(19) United States
(12) Patent Application Publication
(10) Pub. No.: US 2026/0163940 A1
(43) Pub. Date: Jun. 11, 2026

(54) System and method for incorporating artificial intelligence processing capabilities to broadband internet access devices

(71) Applicant: Soma Sekhar Muppidi, Suwanee, GA (US)

(72) Inventor: Soma Sekhar Muppidi, Suwanee, GA (US)

(21) Appl. No.: 19/390,611

(22) Filed: Nov. 16, 2025

Related U.S. Application Data
(60) Provisional application No. 63/730,212, filed on Dec. 10, 2024.

(51) Int. Cl. H04L 67/1008; H04L 41/16

(52) U.S. Cl. CPC H04L 67/1008; H04L 41/16

(57) ABSTRACT

This invention is a method of incorporating Artificial Intelligence processing capabilities to broadband internet access devices that do not have native embedded AI processors. The method utilizes one or more mobile phones which have AI capable processors in them. The architecture, SDK, software modules and drivers needed to implement the distributed system are specified. These involve methods to interface with the phones in a manner that is transparent to the AI application. The methods involve functions to discover and form an AI processor network, set an AI model, update data to the model and get the inference results back to the application among other things. The communication methods define both synchronous and asynchronous methods so that from an application point of view it appears as if the AI processing and inference results are derived locally by the internet access device only.

### CROSS-REFERENCE

This application claims the benefit of U.S. Provisional Patent Application No. 63/730,212 which was filed on Dec. 10, 2024.

### BRIEF DESCRIPTION OF INVENTION

Advances in mobile phone processors are expected to add GPU and custom advanced AI processing capabilities to the devices. Broadband internet access devices like routers, modems, gateways do not have native AI processing capabilities. These devices are part of a home network that provides internet access to users. Service providers are interested in deploying AI applications and services into the home, but the older internet access devices with no embedded AI processing capabilities cannot support these applications that require making inferences and local AI processing capabilities. This invention presents a system and method to add and additionally use these capabilities on traditional broadband internet access devices that do not have AI coprocessing capabilities built into the devices or the processors that are used in the devices. There are hundreds of millions of broadband internet access devices that can benefit with a system that can add AI coprocessing capabilities to these devices. Additionally, the benefit of the current method is that it utilizes mobile phones that are already available with end users and does not require procuring additional hardware. The architecture, SDK, software modules and drivers needed to implement the distributed system are specified.

The method of provisioning AI models is not standard. The methods in this disclosure utilize standard provisioning protocols that can be easily integrated by the network operators. The system defines the ability to provision and configure the AI applications using standard network management methods like TR-069, USP, WebPA, that are familiar with the MSO and Telco network operators. These can be easily integrated into their current back-end OSS and BSS systems to offer the ability to provision AI data models and inference capabilities.

The network inside the home generates a large amount of data that can be used for inference. The system described here provides a way to gather a rich set of data that is sourced from devices in the home including IoT devices, WIFI devices, Wired devices and provide them to the edge AI processor running on the mobile phone, that would otherwise not be available to the mobile phone to make inference decisions locally.

The communication protocol and messaging that is required to set the AI model, configure parameters of the AI model, get inference decisions, get error messages and general status have been specified. The protocol includes both synchronous and asynchronous methods that are required for proper operation. These are defined such that from an application point of view it appears as if the AI processing and inference results are derived locally by the internet access device only. The protocol and messages make additional compute resources that have AI capabilities to be available to older generation internet devices.

### BRIEF DESCRIPTION OF THE DRAWINGS

FIG. 1: MSO/Service Provider Network.

FIG. 1 shows the typical service provider network in which broadband internet access devices are deployed and provide internet access. This is the example network in which a service provider would like to deploy AI applications.

FIG. 2: CPE Home Network.

FIG. 2 shows a network inside the home, office or small business (SMB) that comprises of the broadband internet access device that provides internet access. It forms a home network with various other devices in the house, office or SMB. Some but not all internet access devices have native AI processing capabilities.

FIG. 3: Broadband Internet Access Device

FIG. 3 shows a block diagram of a broadband internet access device. AI applications require dedicated processors called GPUs, NPUs or TPUs that are not always natively available in all broadband access devices controllers.

FIG. 4: AI processor Network

FIG. 4 shows the software modules and the architecture diagram of the invention. The concept of an AI processor network comprising the internet access network along with the AI processors coupled with the device are shown. Also shown are the distributed SW modules resident in each device.

FIG. 5: Communication protocol, synchronous and asynchronous methods

FIG. 5 describes the communication elements used by the broadband internet gateway to manage remote AI models in the mobile phones. The protocol defines methods that are both synchronous and asynchronous.

FIG. 6: Message format and types of messages

Several types of messages are exchanged between the broadband internet device and the one or more coupled AI mobile phones that are capable of executing the AI models. The message format of the messages includes a message type and length field. These fields together inform the end point what type of action is required to be performed. The data is processed based on the type of message and the length field indicates how much data is present. The table in the figure shows the types of messages that are used.

### DETAILED DESCRIPTION

The present disclosure generally relates to mechanisms for incorporating artificial intelligence capabilities to broadband internet access devices and, more specifically to incorporating the artificial intelligence capabilities in a local network device, such as routers, modems, network access points, by utilizing mobile phones that have embedded AI processors.

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

There are a very large number of broadband internet access devices, such as gateways, network access points, and the like, which have been deployed worldwide. Most of these devices do not currently have artificial intelligence (AI) processing capabilities, such as machine learning and generative AI (GAI) algorithms, which require specialized hardware to execute the AI algorithms. These AI processors are needed more and more to support some of the newer applications being developed. In contrast, the more rapidly developing mobile phones keep getting increasingly more powerful with AI capable arithmetic units in processors, along with more powerful embedded graphics processing units (GPUs), being added to each new generation.

Currently, the network providers that control a large part of the operation of broadband internet access devices are beginning to deploy AI technology and applications in next generation devices. However, these network providers have not yet found a convenient and uniform platform to deploy AI applications capabilities on the large number of legacy devices. Therefore, there is a need for a convenient and uniform mechanism for incorporating AI capabilities in broadband internet access devices that otherwise would not have inherent AI capabilities.

These and other drawbacks and disadvantages presented as part of operation of broadband internet access devices and, in particular, legacy type devices that do not inherently have AI capabilities. However, it can be understood by those skilled in the art that the present principles may offer advantages in other types of devices and systems as well.

The present description illustrates the principles of the present disclosure. It will thus be appreciated that those skilled in the art will be able to devise various arrangements which, although not explicitly described or shown herein, embody the principles of the disclosure and are included within its scope. Further, while the embodiments described below are directed towards a specific type of device, the principles of the present disclosure may be applicable to other devices, including other network communication devices, which can benefit from the features described below.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with one or more intermediate components. Such intermediate components may include both hardware and software based components.

AI l examples and conditional language recited herein are intended for educational purposes to aid the reader in understanding the principles of the disclosure and the concepts contributed by the inventor to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated by those skilled in the art that the block diagrams presented herein represent conceptual views of illustrative system components and/or circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, a System on a Chip (SoC), digital signal processor (“DSP”) hardware, read only memory (“ROM”) for storing software, random access memory (“RAM”), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the embodiments hereof, any element expressed or described, directly or indirectly, as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present embodiments address problems and drawbacks associated with running or operating applications and/or functions that utilize AI technologies on broadband internet access devices that have been previously deployed in an existing network (e.g., a cable operator network or a multiple service operator (MSO) network or a telco service provider) and do not include the capabilities to properly execute operations associated with these AI technologies.

For example, these previously deployed broadband internet access devices, referred to as legacy broadband internet access devices or legacy devices, do not have the GPUs and/or the custom SoC AI processors that are necessary to run the latest AI applications or functions. As a result, these legacy devices cannot natively run the newer AI applications. The presence of these legacy devices may prevent the network operators from broadly deploying valuable AI applications, such as fault detection, cybersecurity applications, limiting coverage to only a subset of their network devices that have AI capabilities.

As another example, many of these legacy devices can source a rich set of data from the home using different technologies that are deployed in home devices like IoT, Ethernet, and Wi-Fi networks. Currently, these legacy devices send all this data to the cloud-based AI processing service, where inference decisions are made remotely. Results are provided back to the legacy devices. Such an approach is often an inefficient use of network bandwidth and expensive. Additionally, such an approach may also result in time delays due to network traffic as well as availability of the cloud-based service that makes certain applications impossible to function as designed.

The present embodiments overcome these drawbacks by taking advantage of rapid advancement in mobile phone technology, an industry with much more frequent product turnover. The most modern processors used in mobile phones have added the GPU and custom advanced AI processing capabilities. These capabilities can be utilized and incorporated by creating an interfacing method through a local or home network that can be used to connect the network device to the mobile phone. The interfacing method defines the ability to provision and configure the AI applications using standard network management methods like TR-069, USP, WebPA, that are familiar to network operators as part of their networks. These management methods can be easily integrated into the network's current back-end operations system support (OSS) and basic service set (BSS) systems to offer the ability to provision AI data models and inference capabilities into the legacy network devices.

The interfacing method described here may easily be used as part of a home network system that gathers a rich set of data that is sourced from devices in the home including IoT devices, Wi-Fi devices, and wired devices. The data is provided over the local network to an AI processor running on the mobile phone in order to make inference decisions locally rather than using a cloud AI processing service as described above.

Further, the interfacing method described here as part of a home network may easily be standardized as many or all of the provisioning and configuring element use or are based on provisioning protocols that are already in use or can be easily integrated by the network operators.

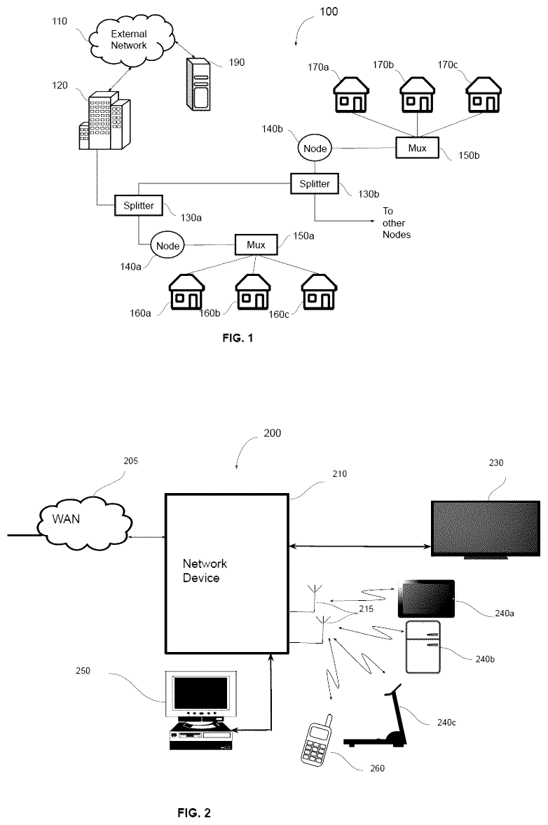

Turning to FIG. 1, an exemplary MSO/service provider network 100 according to aspects of the present disclosure is described. Headend 120 is coupled, as part of MSO network 100, to customer premises 160a-c and 170a-c over a wired communication link through splitters 130a-b, nodes 140a-b, and multiplexers 150a-b. Headend 120 is also coupled to an external network 110 that is used to communicate media and data content between MSO/service provider network 100 and other devices and/or other networks coupled to external network 100 using a private communication link, such as a satellite link, or through a public communication link, such as the internet. Collectively, the other devices or networks may be referred to as the cloud. The media content may include audio content, video content, and/or data associated with the audio content and video content. The communication link between the MSO/service provider network 100 and the other devices or networks through the external network 110 may be bi-directional. As shown, the headend 120 is coupled through external network 110 to application server 190 located in the cloud, as described above.

Headend 120 is a facility used to receive various signals, such as over the air (OTA) broadcast signals, satellite signals, and the like, as well as signals from external network 110, and processes the signals for delivery to customer premises 160a-c and 170a-c. Headend 120 also processes data communication signals transmitted and received to and from other networks through the cloud. Headend 120 contains equipment such as receivers, modulators, transmitter compression equipment, signal multiplexers, and conditional access elements. Headend 120 also includes processors and storage elements configured as servers that provide system and network services, such as advertising or TAD services used for providing targeted advertising content to one or more customer premises 160a-c and 170a-c in MSO/service provider network 100.

Each of customer premises 160a-160c and 170a-170c includes customer premises equipment (CPE) or hardware (not shown) that communicates media and data content between customer premises 160a-170c and 170a-170c and head-end 120 through the splitters 130a-130b, nodes 140a-140b and multiplexers 150a-150b in MSO network 100.

The media and data content may be communicated based on inputs or controls from a customer or user. The CPE or hardware may include one or more communication devices operated by the user to send and receive media content through network 100. These communication devices, often referred to as network access devices or broadband internet access devices, may include, but are not limited to, a set-top box, a gateway, a modem, a laptop, a tablet, and the like. Additionally, one or more of these communication devices may be supplied and controlled or managed by the service provider operating network 100. An exemplary communication device will be described in further detail below.

Application server 190 provides applications and application content for use as part of the operation of network 100. Application server 190 includes a network interface for communicating with head-end 120 and/or the CPE through external network 110. application server 190 also includes one or more processors configured to process information associated with advertisement profiles for users that are created by the CPE. Application server 190 further includes storage resources in the form of both short-term storage, such as electronic memory, and long-term storage in the form of magnetic or optical disk memory. For example, application server 190 may include the ability to maintain a set of applications that utilize AI technologies and can be used as part of the operation of devices or CPE in one or more of customer premises 160a-160c and 170a-170c.

As part of the operation of network 100, a communication device, such as a broadband internet access device, in one or more of customer premises 160a-160c and 170a-170c includes software that is capable of interfacing the network access device to a device that includes AI capabilities through a home or local network at the customer premises. The software in the network access device may further receive notifications and information from other devices connected to the local or home network. One or more of the other network devices may be associated with IoT and may include, but are not limited to, exercise equipment, refrigerators, cooking appliances, cleaning appliances, security devices, safety devices, gaming equipment, and other home electronic equipment.

Turning to FIG. 2, a block diagram of an exemplary home network 200 according to aspects of the present disclosure is shown. Home network 200 may operate in a customer residence, such as one or more of customer premises 160a-160c and 170a-170c. Further home network 200 may operate as one of several home networks in a customer residence that co-exist and may or may not operate together in a co-operative manner. Home network 200 may operate through wired and/or wireless network connection medium utilizing one or more protocols including, but not limited to Ethernet, Institute of Electrical and Electronics Engineers (IEEE) standard 802.11, Wi-Fi, IEEE standard 802.3 (Ethernet), Wi-Fi, Bluetooth, Zigbee, and the like. It is worth noting that several components and interconnections necessary for complete operation of home network 200 are not shown in the interest of conciseness, as the components not shown are well known to those skilled in the art.

In home network 200, a network device 210 is connected to an external network 305 via a wired WAN interface. Network device 210 is further connected to a television device 330 via an audio/video interface as well as gaming console 250 via wired Ethernet interface. Network device 210 is also connected to a tablet device 240a, a refrigerator 240b, and a treadmill 240c via a wireless LAN interface 215. Network device 210 is additionally connected to a wireless or cellular telephone 260 via the wireless LAN interface 215.

Network device 210 operates and functions similar to the communication device described as part of network 100 in FIG. 1. Network device 210 provides a network interface to WAN 205 in order to transmit and receive media content and data with other devices on a service operator or service provider system, such as head-end 120 in service provider network 100 in FIG. 1. Network device 210 further provides one or more network interfaces (e.g., wired Ethernet or wireless interfaces) to a LAN at the customer's home or premises allowing transfer of media content and/or data to and from other devices connected to the LAN.

In an operation, home network device 210 may be configured to provide media content to television device 230 from the service or content provider system (e.g., MSO network 100 in FIG. 1). Additionally, network device 210 may be configured to request and receive data and information associated with a browsing history or favorite search queries from tablet device 240a. Also, network device 210 may be configured to request and receive a list of identified products found inside refrigerator 240b at different points in time from refrigerator 240b as well as a usage history, such as miles logged or time spent, over a period of time from treadmill 240c. Further, network device 210 may request and receive a list of games played as well as time spent for each game from gaming console 250. AI l of the information provided from the devices over the LAN may be processed for use in applications used as part of the operation of network device 210. Further, one or more of these applications running on network device 210 may incorporate functions that utilize AI technologies, such as machine learning and/or GAI algorithms. Network device 210 further interfaces with wireless or cellular telephone 260 in order to utilize and incorporate the AI technologies present in wireless or cellular telephone 260 as part of running these applications.

Turning to FIG. 3, a block diagram of an exemplary communication device 300 according to aspects of the present disclosure is shown. Communication device 300 may operate as part of a home network or local network (LAN), such as home network 200 described in FIG. 2, that is connected to a wide area network (WAN), such as MSO network 100 described in FIG. 1. The WAN may provide consumer content, such as audio, video, and or data content to communication device 300 for further distribution over a local area network (LAN) in a customer's premises (e.g., customer premises 160a-160c and 170a-170c). The WAN may operate as one or more of a terrestrial, cable, satellite, or cellular communication network. The LAN may operate as a wired or wireless network and may be connected to other home devices, such as those described in FIG. 2. In addition, the home devices may also include, but are not limited to, a handheld radio, a set-top box, a streaming device, a router, a cellular or wireless outdoor unit, a media content player and the like. The home devices may also work with other appliance type devices as part of an internet of things (IoT) network. In addition to the devices mentioned in FIG. 2, these appliance type devices may include, but are not limited to, stoves, lighting devices, heating and cooling devices, washers, dryers, other home exercise equipment, and the like. The LAN may utilize one or more protocols including, but not limited to Ethernet, Institute of Electrical and Electronics Engineers (IEEE) standard 802.11, Wi-Fi, Bluetooth, Zigbee, and the like. It is worth noting that several components and interconnections necessary for complete operation of communication device 300 are not shown in the interest of conciseness, as the components not shown are well known to those skilled in the art.

In communication device 300, a wide area network (WAN) is coupled to WAN transceiver 370 either through antenna 372 or through a direct network interface connection. WAN transceiver 370 is coupled to signal processor 315. Signal processor 315 is coupled to memory 390. Signal processor 315 is further coupled to audio/video interface 320, wireless local area network (WLAN) transceiver 340, WLAN transceiver 350, and Ethernet interface 360. WLAN transceiver 340 is coupled to antenna 342. WLAN transceiver 350 is coupled to antenna 352 and antenna 354. A user interface 380 is coupled to controller 310.

WAN transceiver 370 includes circuitry to perform network RF signal modulation and transmission functions on a signal provided to the WAN through antenna 372 or direct network connection from communication device 300 as well as RF signal tuning and demodulation functions on a signal received from the WAN through antenna 372 or direct network connection at communication device 300. RF modulation and demodulation functions are the same as those commonly used in communication systems, such as cable, satellite, digital subscriber line, or over the air terrestrial systems. These functions may include, but are not limited to, amplifiers, filters, frequency converters, analog/digital converters, demodulators, decoders, modulators, encoders, and the like. It is worth noting that in some embodiments, the WAN transceiver 370 may be referred to as a tuner even though WAN transceiver 370 may also include modulation and transmission circuitry and functionality. Signal processor 315 receives the demodulated network communication signals from WAN transceiver 370 and any provides any data or content from other elements in communication device (e.g., WLAN transceiver 340, 350), formatted for network delivery over the WAN, to WAN transceiver 370. WAN transceiver 370 may also include circuitry for signal conditioning, filtering, and/or signal conversion (e.g., optical to electrical signal conversion). Antenna 372 may be any type of antenna suitable for transmitting and/or receiving signals in the frequency range or ranges used by the WAN. The type of antenna may include, but is not limited to, a dipole antenna, a high gain patch antenna, a parabolic dish antenna, and the like. In some embodiments, antenna 372 may be located outside the mechanical structure of communication device 300 rather than within, as shown.

Audio/video interface 320 allows connection to an audio/video reproduction or display device, such as a television display device described above or other media device, such as a set top box, that is coupled to an A/V display device. Audio/video interface 320 may include additional signal processing circuitry including, but not limited to, digital to analog converters, signal filters, digital and/or analog signal format converters, modulators, demodulators, and the like. Audio/video interface 320 also includes one or more physical connectors to connect to the audio/video reproduction device using one or more of several different types of audio/video connecting cables. The one or more physical connectors may include, but are not limited to, RCA or phone type connectors, HDMI connectors, digital visual interface (DVI) connectors, Sony/Philips digital interface (S/PDIF) connectors, Toshiba Link (Toslink) connectors, and F-type coaxial connectors.

Ethernet interface 360 allows connection to external devices (e.g., computer 250 described in FIG. 1) that are compliant with the IEEE 802.3 or similar communication protocol. Ethernet interface 360 includes a type RJ-45 physical interface connector or other standard interface connector to allow connection to an external local computer, gaming device, and/or other Ethernet connected device.

WLAN transceiver 340, along with antenna 342, and WLAN transceiver 350, along with antennas 352 and 354, provide a wireless communication interface to other devices in a home network or LAN. WLAN transceiver 340 and WLAN transceiver 350 may include various electronic circuits for performing the receiving and demodulation functions on signals received from other devices through antenna 342 and antennas 352 and 354, respectively. WLAN transceiver 340 and WLAN transceiver 350 may also include various electronic circuits for performing the modulation and transmitting functions on signals transmitted to other devices through antenna 342 and antennas 352 and 354, respectively. The various functions may be similar to those described above for WAN transceiver 370. Antennas 342, 352, and 354 may be any type of antenna suitable for transmitting and/or receiving signals in the frequency range or ranges used by the LAN. In some embodiments, one or more antennas 342, 352, and 354 may be located outside the mechanical structure of communication device 300 rather than within, as shown.

Signal processor 315 receives signals containing digital content and/or data from WAN transceiver 370 and processes the digital media content (e.g., audio/video content) and/or data to provide as signals for use through audio/video interface 320, Ethernet interface 360, WLAN transceiver 340, and/or WLAN transceiver 350. Signal processor 315 further receives signals containing digital media content and/or data from Ethernet interface 360, WLAN transceiver 340, and/or WLAN transceiver 350 and processes the digital media content and/or data to provide signals for use through audio/video interface 320, Ethernet interface 360, and/or WAN transceiver 370. The processing in signal processor 315 may include, but is not limited to, data format conversion, data repackaging, error correction, data delivery management, arithmetic or logical function processing, and the like. Signal processor 315 may also include processing to perform digital rights management authentication for content as well as content access control. Signal processor 315 may be embodied as part of an application specific integrated circuit (ASIC) or as a programmable signal processing device that is reconfigurable with downloadable instructions or software code stored in memory 390. Signal processor 315 may alternatively be a specifically programmed data signal processor with internal control code for processing signals and data in communication device 300.

User interface 380 may include a user input or entry mechanism, such as a set of buttons, a keyboard, or a microphone. User interface 380 may also include circuitry for converting user input signals into a data communication format to provide to controller 310. User interface 380 may further include some form of user notification mechanism to show device functionality or status, such as indicator lights, a speaker, or a display. User interface 380 may also include circuitry for converting data received from controller 310 to signals that may be used with the user notification mechanism.

Controller 310 receives signals and data from user input interface 180. The controller 210 processes the user input signals and data and may generate control instructions to adjust operation of communication device 300 based on these inputs. Controller 310 may also generate signals and data and provide the signals and data to user interface 380. Controller 310 may also manage communication network configuration and security authentication and/or access control for one or both of the WAN through WAN transceiver 370 and the LAN through LAN transceivers 340 and 350. Controller 310 also monitors status and operations of the various components in communication device 300.

Controller 310 also includes program instructions that configure controller 310 to run one or more applications associated with configuring communication device to interface with an external device (e.g., a cellular or mobile phone) on a LAN through a LAN transceiver (e.g., LAN transceiver 340 or LAN transceiver 350) as part of processing data using AI technology (e.g., machine learning or GAI algorithms). The applications may be requested from service operator facilities, such as head-end 110 and/or applications database 190 described in FIG. 1, over a WAN using WAN transceiver 370.

For example, an application may be requested from an application database that requires use of AI technology as part of its operation. The program instructions in the provided application may configure controller 310 to run a communication module as part of interfacing and communicating with the external device as part of accessing the AI processing circuitry in the external device. The program instructions may additionally configure controller 310 to run a data collection module as part of interfacing with and collecting data from other external devices (e.g., IoT devices, etc.) on the LAN as part of providing the data needed by the AI processing circuitry in the external device. The program instructions may further configure controller 310 to run an AI data model/provisioning manager as part of receiving requests from the service operator made over the WAN for the results of processing the collected data through the AI processing circuitry in the external device.

Controller 310 may be embodied as a programmable microprocessor that is reconfigurable with downloadable instructions or software code stored in memory 390. Controller 310 may alternatively be a specifically programmed processing device with internal control code for managing and controlling operations in communication device 300. It is worth noting that, in some embodiments, controller 310 and signal processor 315 may be combined into a single processing unit. In these embodiments, the single processing unit may be referred to as a processor or a central processing unit (CPU).

Memory 390 supports the content and data processing as well as IP functions in signal processor 315 and also serves as storage for applications, programs, control code and media content and data information for controller 310 and signal processor 315. For example, system memory 390 may store the instructions associated with the TAD module as well as information associated with the user's viewing habits as well as the information obtained from the network or internet connected devices in the user's premise. In some embodiments, system memory may store targeted advertising content provided by an advertising content server (e.g., application server 190 in FIG. 1) and displayed to the user. System memory 3290 may include one or more of the following short term storage memory elements including, but not limited to, RAM and flash memory. System memory 390 may further include one or more of the following longer term or permanent storage memory elements including, but not limited to, ROM and electronically erasable programmable ROM (EEPROM). System memory 390 may also encompass one or more integrated memory elements including, but not limited to, magnetic media hard disk drives and optical media disk drives.

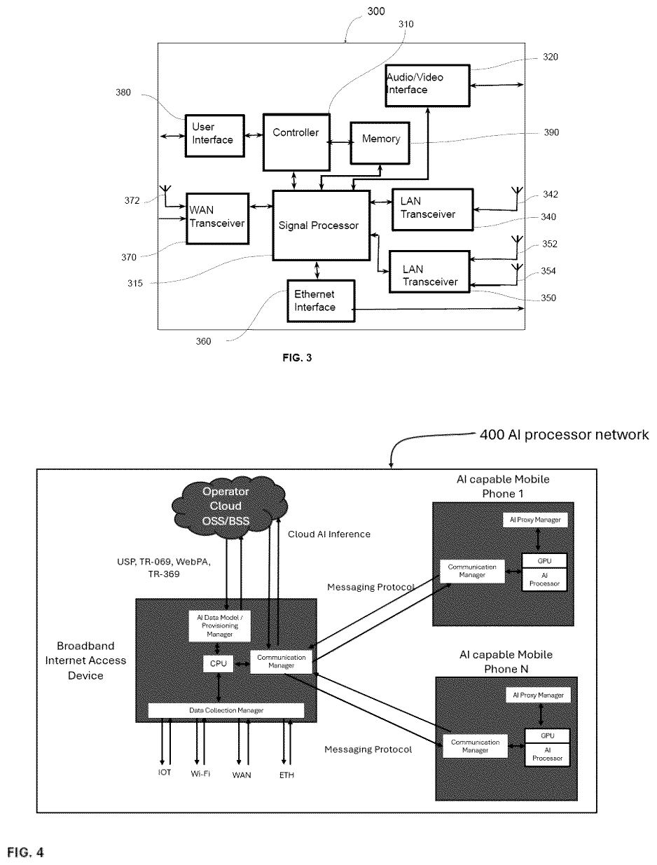

Turning to FIG. 4, a software and protocol diagram of an exemplary network 400 according to aspects of the present disclosure is shown. Network 400 that is part of the current disclosure, is the AI processor network that consists of an internet access device and one or more AI processors that are coupled with the internet access device. It is worth noting that several software components and protocol elements necessary for complete operation of network 400 are not shown or described in the interest of conciseness, as the components or elements not shown or described are well known to those skilled in the art.

There is a lot of value in being able to add AI capabilities to legacy internet access devices. Network 400 described here offers a way for network providers to deploy the same applications uniformly on newer access devices that have embedded AI capabilities as well as legacy internet devices that do not have the AI capabilities built in. The protocol structure allows for the use of the mobile phone as a co-processor for AI (e.g., GPU and AI operations) to enhance the capabilities of the broadband internet access device.

The software architecture, SDK, software modules and drivers needed to implement the system on an internet access device. These involve methods to interface with the phone in a manner that is transparent to the AI application. The methods involve functions to set an AI model, update data to the model and get the inference results back to the application. The communication methods define both synchronous and asynchronous methods so that from an application point of view it looks as if the results are being returned by the internet access device only.

The following is a description of the main modules in the broadband internet access device and the mobile as shown in FIG. 4:
Communication Manager: There are two instances of this module. One is resident on the internet access device and the other on the AI capable mobile phone. The function is to provide synchronous and asynchronous communication to and from the AI resources on the phone. This includes set model data, updating model data, getting model data and publishing events from the phone.
AI Proxy Manager: Resident manager on the phone that is responsible for reading the requests coming from the communication module and utilizing the AI resources on the phone. This module also sends the data from the computation back to the internet device
AI Data Model/Provisioning Manager: This is a process that reads incoming requests from network operators using standard provisioning messages and sends the requests using the communication module to the AI capable mobile phone. This model also processes results from the mobile phone and returns data back to the network operator.
Data collection Module: Responsible for collecting the required data from various interfaces-IoT, WIFI, Ethernet and WAN. The data collection module uses the services of the communication module to update data required for the AI modules running on the mobile platform.

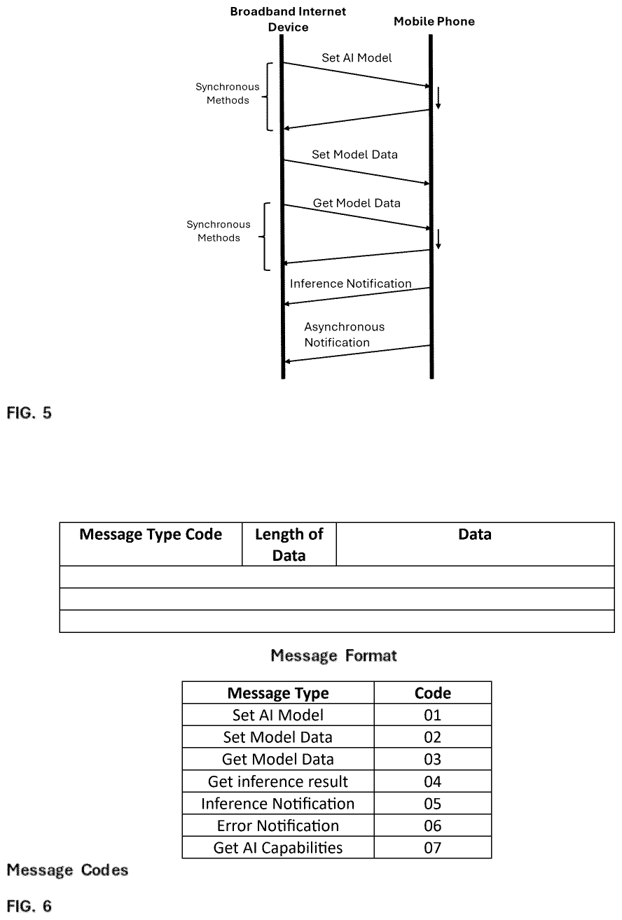

FIG. 5 shows a signal flow diagram for configuring and managing the use of AI circuitry in an external device, such as mobile phone, by a network device, such as a broadband internet device. The operation of the network device may be similar to the operation of communication device 300 described in FIG. 3 or the broadband internet access device in FIG. 4. As an initial step, an application is initiated for execution in the network device. As part of the initiation, the communication interface establishes a proxy protocol to allow the network device to access the AI circuitry in the external device. During execution, the network device provides instructions to the external device to set the AI model characteristics for use as part of the application. Once the AI model is set, the network device provides instructions to the external device to set the model data characteristics for use as part of the application. After setting the model data characteristics, the model data collected by the network device is transferred to the external device. Once the model data is processed by the AI circuitry in the external device using the AI model, the external device provides an inference notification to the network device as part of the results from the processing. In the case of a synchronous message the software module originating the message waits for the response to be received. In the case of an asynchronous message the software module that originates the request does not wait for the response to be received.

Turning to FIG. 6, several types of messages are exchanged between the broadband internet devices and the coupled AI mobile phones that are capable of executing the AI models. The message format of the messages includes a message type and length field.

The message type field describes what type of message is being exchanged and the length field indicates the length of data. These fields together inform the end point what type of action is required to be performed. The data is processed based on the type of message. The length field indicates how much data is present. For a set method the data is used as input received and for a get method the data is output. The types of messages that are used by the protocol are described below:
Set AI Model: This message is used typically as part of a synchronous executing to load the pretrained AI model on the mobile phone.
Set Model Data: This message is used to set the parameters of the AI model. Typically, this is set by data that is collected by the data collection module with data that is sourced from the home network.
Get inference result: This message is used to poll the mobile phone to retrieve the inference result.
Get Model Data: Typically, used as a synchronous message to get the model data from the AI mobile phone
Inference Notification: For models that require extended time to draw an inference from the data, the inference notification message is used by the phone to let the internet access device of an inference result.
Error notification: This message is used to indicate an error condition from the phone to the access device.
Get AI capabilities: This message is sent periodically to poll the AI processor network to maintain a mapping of the AI capabilities. The internet access device maintains the information of all active mobile devices in use by building a mapping like the one below.

| End Point | Application |
|---|---|
| AI End Point 1 | App ID 1 |
| AI End Point 2 | App ID 2 |
| AI End Point N | App ID N |

It is to be appreciated that, except where explicitly indicated in the description above, the various features shown and described are interchangeable, that is, a feature shown in one embodiment may be incorporated into another embodiment.

The interfacing method and associated systems described above further offer a cost-efficient and network bandwidth efficient method to add AI coprocessing to legacy broadband internet access devices to allow these devices to benefit from the same applications and functions available to newer broadband internet access devices. Further, the interfacing method and associated systems have many practical applications in a service operator network as a result of unifying the operations and functions of newer broadband internet access devices that have AI capabilities and the older, legacy broadband internet access devices that do not have these capabilities.

AI though embodiments which incorporate the teachings of the present disclosure have been shown and described in detail herein, those skilled in the art can readily devise many other varied embodiments that still incorporate these teachings. Having described preferred embodiments of a system and method for incorporating artificial intelligence capabilities to broadband internet access devices, it is noted that modifications and variations can be made by persons skilled in the art in light of the above teachings.

1: The method of using mobile phones as AI processors for internet access devices that do not have native embedded AI processing capabilities, the system comprising of:
(i). a Communication Manager that provides synchronous and asynchronous communication to and from the AI resources on a mobile phone to and from the internet access device;
(ii). an AI Proxy Manager that is resident on a mobile phone;
(iii). AI Data Model Provisioning Manager that allows the configuration of AI model;
(iv). Data Collection Manager that collects data in real time and sends to AI model; and
(v). messaging protocol and message formats with specific message types.

2: The method of claim 1, wherein multiple mobile phones can be coupled with one internet access device for access to multiple remote computing elements.

3: The method of claim 1, wherein the Communication Manager in the internet access device acts as a master controller and schedules workloads to the remote computing elements by implementing a mapping of the application to the end points, which are mobile phones.

4: The method of claim 1, wherein the Communication Manager employs both synchronous and synchronous methods of communication with mobile phone processors to set the AI model and retrieve the inference results.

5: The method of claim 1, wherein the Communication Manager periodically scans the home network for AI capabilities of mobile phones and maintains a mapping of end point to AI capabilities.

6: The method of claim 1, wherein the Communication Manager makes the decision if the data required for an AI inference should be sent to one of the phones processors that are part of the local home network or to the cloud to process the data by an AI model.

7: The method of claim 1, wherein the AI Interface Proxy Manager will respond to polling requests from the Communication Manager of the internet access device responding with AI capabilities of the mobile phone to enable the internet gateway to discover the AI processing capabilities on the phones in the home network.

8: The method of claim 1, wherein the interfacing method through internet access device's AI Data Model and Provisioning manager defines provisioning and configuration of the AI models by employing standard network management protocols like TR-069, USP, WebPA, that are familiar to network operators and can be integrated into their OSS and BSS systems.

9: The method of claim 1, wherein the messaging protocol defines the message format and message codes to exchange AI model, model parameters, run inference and get error codes to and from the remote AI processor.

| Message Type | Code |
|---|---|
| Set AI Model | 01 |
| Set Model Data | 02 |
| Get Model Data | 03 |
| Get inference result | 04 |
| Inference Notification | 05 |
| Error Notification | 06 |
| Get AI Capabilities | 07 |

10: The method of claim 1, wherein the Data Collection Manager gathers real time data and events from a variety of networks inside the home like ethernet, wireless, IoT, fiber and coax cable, and sends this information using the Communication Manager to either the AI Proxy Manager in the mobile phone for processing or to a cloud hosted AI model.

11: The method of claim 1, whereby ubiquitous deployment of AI applications can be achieved in service provider networks across both newer generations of internet access devices with native AI computing capabilities and older devices which do not have such native processing capabilities.
